(19) United States
(12) Patent Application Publication
(10) Pub. No.: US 2015/0145409 A1
(43) Pub. Date: May 28, 2015

(54) AUTOMOTIVE LED BLEED RESISTOR CIRCUIT AND BODY CONTROL MODULE INTERRUPT WAKEUP CIRCUIT

(71) Applicant: Panasonic Automotive Systems Company of America, Division of Panasonic Corporation of North America, Peachtree City, GA (US)

(72) Inventor: Joseph C. Whitaker, Sharpsburg, GA (US)

(73) Assignee: Panasonic Automotive Systems Company of America, Division of Panasonic Corporation of North America, Peachtree City, GA (US)

(21) Appl. No.: 14/089,872

(22) Filed: Nov. 26, 2013

(51) Int. Cl. B60Q 3/02

(52) U.S. Cl. CPC B60Q 3/0293
USPC 315/77

(57) ABSTRACT

A motor vehicle includes a processor having an interrupt input. A battery includes a positive terminal. A switch interconnects the positive terminal of the battery and the interrupt input of the processor. A first resistor interconnects the positive terminal of the battery and the interrupt input of the processor. A light emitting diode includes an input and an output. A second resistor interconnects the input of the light emitting diode and the interrupt input of the processor. A third resistor is connected in parallel with a series combination of the second resistor and the light emitting diode.

### BACKGROUND OF THE INVENTION

1. Field of the Invention

The present invention relates to circuits for detecting burned out light emitting elements, and, more particularly, to circuits for detecting burned out light emitting elements within a motor vehicle.

2. Description of the Related Art

The existing technology of body control modules (BCMs) of most automotive manufacturers uses a very low trickle current to detect the intact filament of an incandescent bulb. This trickle current is used to display a status of burned out bulbs to the driver. However, unlike the incandescent bulbs this circuit was designed for, the LEDs tend to glow slightly with this trickle current. This slight glow actually does not reduce battery life, but it does create a concern for most vehicle owners who do not understand that the current is too low to drain the battery.

A known BCM circuit 10 is illustrated in FIG. 1. Circuit 10 includes a battery 12, a resistor 14, an incandescent bulb 16, a BCM controlled high-side switch 18, a user controlled push button switch 20, and a BCM 22. Circuit 10 make use of the low impedance of the cold incandescent bulb 16 to turn on a sleeping BCM. When the user wishes to use switch 20 to turn on an interior light including bulb 16 while the ignition of the vehicle is off, the BCM has to be triggered to wake up to supply the current for that bulb 16 via high side switch 18. Typically, the circuit is wired so that closing switch 20 connects bulb 16 to ground and the circuit acts to pull down a logic line 24 wired to the BCM interrupt.

When the car ignition is OFF and when the user controlled push button switch 20 closes, the low impedance of incandescent bulb 16 pulls the line low to near ground and triggers the BCM interrupt to wake BCM microprocessor 22. The BCM then may close the BCM controlled high-side switch 18 and light 16 turns ON. This feature has been present in automotive interior lighting circuits for many years. It makes use of the very low impedance property of cold incandescent bulbs when OFF.

Although circuit 10 works fine with an incandescent bulb 16, it fails with a light emitting diode (LED) because the LED has a fixed non-zero voltage drop and cannot pull the line low enough to successfully trigger the interrupt. Thus, the car owner is not able to turn on an interior light when the car is off.

It would be possible to add a second wire to the wiring harness for the only the purpose of providing an interrupt line. However, in addition to the cost of the second wire, this would require a double pole double throw (DPDT) switch which is more expensive than the single pole double throw (SPDT) switch that is currently used in known circuits.

Another alternative to solve the above-described problems is to redesign the BCM and its circuitry to work explicitly with LEDs. However, even with a redesigned BCM, a resistor for the BCM interrupt would still be needed.

### SUMMARY OF THE INVENTION

The invention may provide a circuit that both prevents glow of an LED and is able to pull the interrupt of a BCM low in order to provide power to the LED, and does so at a minimal cost.

The invention comprises, in one form thereof, a motor vehicle including a processor having an interrupt input. A battery includes a positive terminal. A switch interconnects the positive terminal of the battery and the interrupt input of the processor. A first resistor interconnects the positive terminal of the battery and the interrupt input of the processor. A light emitting diode includes an input and an output. A second resistor interconnects the input of the light emitting diode and the interrupt input of the processor. A third resistor is connected in parallel with a series combination of the second resistor and the light emitting diode.

The invention comprises, in another form thereof, a vehicle lighting circuit including a body control module having an interrupt input. A battery includes a positive terminal. A first switch interconnects the positive terminal of the battery and the interrupt input of the processor. A first resistor interconnects the positive terminal of the battery and the interrupt input of the processor. A light emitting element includes an input and an output. A second resistor interconnects the input of the light emitting element and the interrupt input of the processor. A third resistor is connected in parallel with a series combination of the second resistor and the light emitting element. A second switch interconnects the output of the light emitting element and electrical ground.

The invention comprises, in yet another form thereof, a vehicle light assembly including a body control module having an interrupt input. A battery includes a positive terminal. A first switch interconnects the positive terminal of the battery and the interrupt input of the processor. A first resistor interconnects the positive terminal of the battery and the interrupt input of the processor. A light emitting element includes an input and an output. A second resistor interconnects the input of the light emitting element and the interrupt input of the processor. A third resistor is connected in parallel with either the light emitting element or a series combination of the second resistor and the light emitting element. A second switch interconnects the output of the light emitting element and electrical ground.

An advantage of the present invention is that the addition of the resistor has an insignificant monetary cost compared to the cost of the second wire and the DPDT switch.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of one embodiment of a BCM circuit of the prior art.

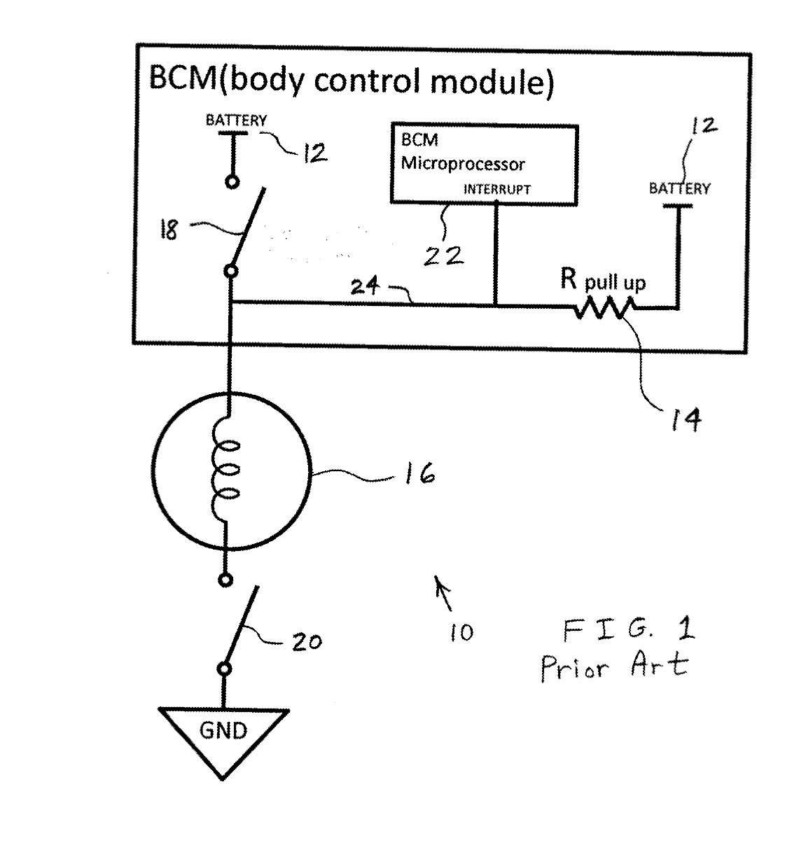

FIG. 2 is a schematic diagram of another embodiment of a BCM circuit.

FIG. 3 is a schematic diagram of one embodiment of a BCM circuit of the present invention.

FIG. 4 is a schematic diagram of another embodiment of a BCM circuit of the present invention.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

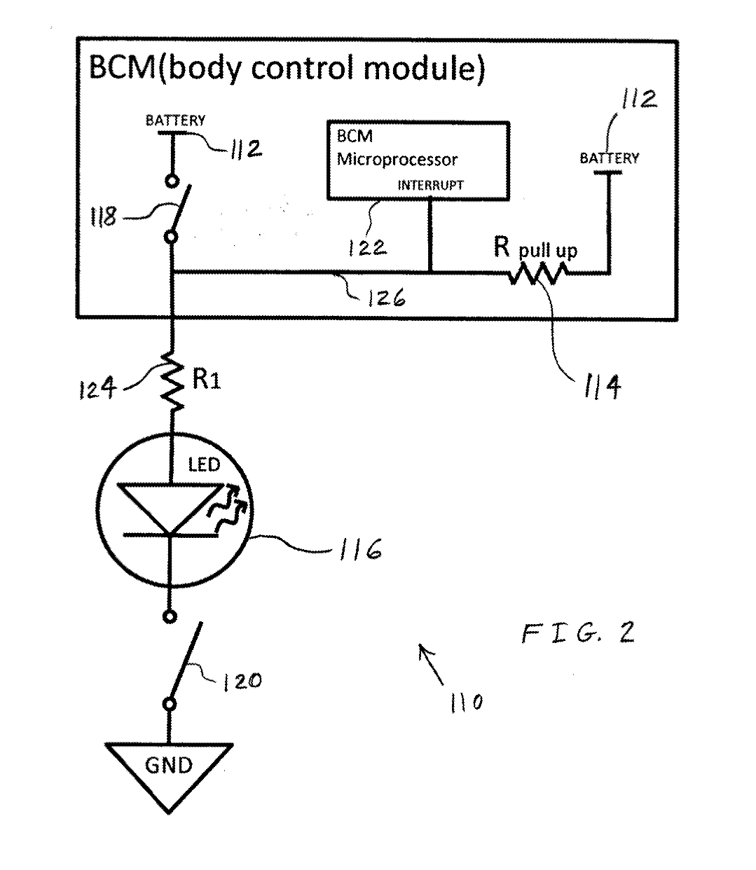

A BCM circuit 110 is illustrated in FIG. 2. Circuit 110 includes a battery 112, a pull up resistor 114, a light emitting diode (LED) 116, a BCM controlled high-side switch 118, a user controlled push button switch 120, a BCM 122, and a resistor 124. A problem is that when user-controlled push button switch 120 closes, the magnitude of the LED V_{FD} may prevent an interrupt line 126 from being pulled low enough to trigger the BCM interrupt, and thus microprocessor 122 may not start, and LED 116 may not turn ON.

Another problem is that when the car is OFF, if the push button switch has been left closed, then the trickle current through pull up resistor 114 may be enough to make LED 116 glow slightly. Even though the trickle glow is low enough to not endanger the battery for many weeks, many car owners nevertheless return to the car dealer for warranty repair.

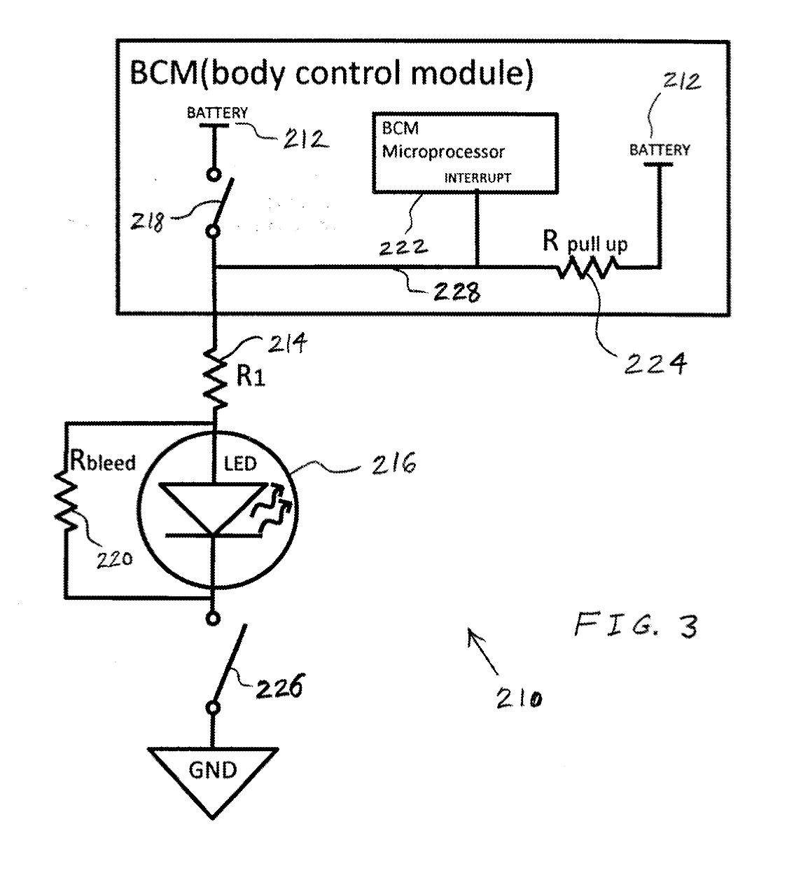

An inventive BCM circuit 210 is illustrated in FIG. 3. In order to prevent the glow of the LED, which may cause concern to the vehicle owner, the LED may be bypassed with a resistor 220 connected in parallel therewith. Circuit 210 also includes a battery 212, a resistor 214, a high current LED 216, a BCM-controlled high-side switch 218, a BCM 222, a pull up resistor 224, and a user-controlled push button switch 226. This circuit 210 may work well in high current LED applications, but a low current LED (e.g., with resistor 214 having a high resistance) may not work properly with such an LED-only bypass because bypass resistor 220 can also bypass the desired low LED current and make that low current LED nonfunctional. In this case, there may be no value of resistor 220 that can solve the trickle glow problem without compromising the normal operation of LED 216. Another problem is that interrupt line 228 still cannot be pulled low.

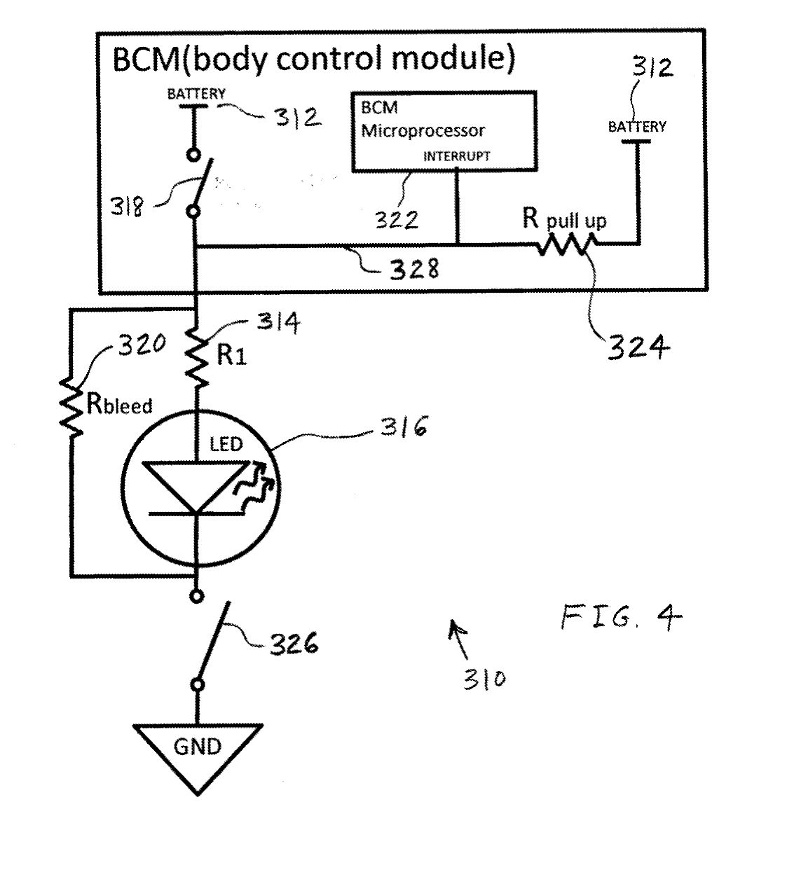

FIG. 4 illustrates a circuit 310 of the present invention, including a battery 312, a resistor 314, an LED 316, a BCM-controlled high-side switch 318 and a resistor 320 connected in parallel with the series combination of resistor 314 and LED 316. Circuit 310 also includes a BCM 322, a pull up resistor 324, and a user-controlled push button switch 326.

Resistor 320 bypasses the combination of LED 316 and series dropping resistor 314. Thus, the amount of current being drawn from the battery may not be substantially affected by resistor 314. A value may be chosen for resistor 320 which results in resistor 320 drawing enough of the trickle current to avoid the trickle glow for an LED designed to operate at any current. At the same time, the value of resistor 320 may be chosen to be low enough to pull interrupt line 328 close enough to ground to trigger the interrupt.

A value of approximately 6.2 k ohms for resistor 320 may work for a wide range of combinations of LED-series-resistor, including those at low bias currents. This invention may be applied to LEDs ranging from those used in headlights to very low current indicator LEDs.

Interrupt line 328 can be pulled down by a resistance much smaller than that of pull up resistor 324. For these instances, the approximately 6.2 k ohms value of resistor 320 could be changed to approximately 1 k ohms. This should be enough to significantly pull down a pull up resistor 324 as low as 27 k ohms to below 0.6V which is low enough to trigger most all interrupt logic level inputs. Resistor 324 may have a resistance of at least 25 k ohms. When the highside switch 318 is ON and the battery is 14V, a resistor 320 of 1 k ohm may draw 14 mA of current and 200 mW of power. In general, resistor 320 may have a resistance of approximately between 800 ohms and 7,000 ohms. In one embodiment, a common 1206 surface mount resistor may be used as resistor 320. Thus, circuit 310 may enable an interior light to be turned ON when the car ignition is OFF without modifying the BCM to specifically address the use of an LED.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A motor vehicle, comprising:
a processor including an interrupt input;
a battery including a positive terminal;
a switch interconnecting the positive terminal of the battery and the interrupt input of the processor;
a first resistor interconnecting the positive terminal of the battery and the interrupt input of the processor;
a light emitting diode including an input and an output;
a second resistor interconnecting the input of the light emitting diode and the interrupt input of the processor; and
a third resistor connected in parallel with a series combination of the second resistor and the light emitting diode.

2. The vehicle of claim 1 wherein the switch comprises a first switch, the vehicle further comprising a second switch interconnecting the output of the light emitting diode and electrical ground.

3. The vehicle of claim 2 wherein the second switch is configured to be controlled by a user.

4. The vehicle of claim 1 wherein the switch is configured to be controlled by the processor.

5. The vehicle of claim 4 wherein the switch comprises a push button switch.

6. The vehicle of claim 1 wherein the third resistor has a resistance of approximately between 800 and 7000 ohms.

7. The vehicle of claim 6 wherein the first resistor has a resistance of at least 25,000 ohms.

8. A vehicle lighting circuit, comprising:
a body control module including an interrupt input;
a battery including a positive terminal;
a first switch interconnecting the positive terminal of the battery and the interrupt input of the body control module;
a first resistor interconnecting the positive terminal of the battery and the interrupt input of the body control module;
a light emitting element including an input and an output;
a second resistor interconnecting the input of the light emitting element and the interrupt input of the body control module;
a third resistor connected in parallel with a series combination of the second resistor and the light emitting element; and
a second switch interconnecting the output of the light emitting element and electrical ground.

9. The circuit of claim 8 wherein the light emitting element comprises a light emitting diode.

10. The circuit of claim 8 wherein the first switch is configured to be controlled by the body control module.

11. The circuit of claim 8 wherein the second switch is configured to be controlled by a user.

12. The circuit of claim 11 wherein the second switch comprises a push button switch.

13. The circuit of claim 8 wherein the third resistor has a resistance of approximately between 800 and 7000 ohms.

14. The vehicle of claim 8 wherein the first resistor has a resistance of at least 25,000 ohms.

15. A vehicle light assembly, comprising:
a body control module including an interrupt input;
a battery including a positive terminal;
a first switch interconnecting the positive terminal of the battery and the interrupt input of the body control module;
a first resistor interconnecting the positive terminal of the battery and the interrupt input of the body control module;
a light emitting element including an input and an output;
a second resistor interconnecting the input of the light emitting element and the interrupt input of the body control module;
a third resistor connected in parallel with one of:
the light emitting element; and
a series combination of the second resistor and the light emitting element; and
a second switch interconnecting the output of the light emitting element and electrical ground.

16. The assembly of claim 15 wherein the light emitting element comprises a light emitting diode.

17. The assembly of claim 15 wherein the first switch is configured to be controlled by the body control module.

18. The assembly of claim 15 wherein the second switch comprises a push button switch configured to be controlled by a user.

19. The assembly of claim 15 wherein the third resistor has a resistance of approximately between 800 and 7000 ohms.

20. The vehicle of claim 15 wherein the first resistor has a resistance of at least 25,000 ohms.
